(19) United States
(12) Patent Application Publication
(10) Pub. No.: US 2006/0198924 A1
(43) Pub. Date: Sep. 7, 2006

(54) METHODS FOR MANUFACTURING COATED CONFECTIONERY PRODUCTS

(76) Inventors: Joo Song, Chicago, IL (US); Kangwook Lee, Naperville, IL (US); Donald A. Seielstad, Frankfort, IL (US); Jonathan Knutsen, Brookfield, IL (US); Holly Schmidt, Chicago, IL (US)

Correspondence Address: BELL, BOYD & LLOYD LLC, P. O. BOX 1135, CHICAGO, IL, 60690-1135, US

(21) Appl. No.: 11/383,643

(22) Filed: May 16, 2006

Related U.S. Application Data
(63) Continuation-in-part of application No. 11/024,214, filed on Dec. 22, 2004.
Application No. 11/024,214 is a continuation-in-part of application No. 10/218,991, filed on Aug. 14, 2002.

(51) Int. Cl. A23G 4/00

(52) U.S. Cl. 426/3; 426/302

(57) ABSTRACT

Methods for manufacturing coated confectionery products are provided. In an embodiment, the method of manufacturing a coated confectionery comprises providing a confectionery, heating sorbitol to the sorbitol's melting point to produce a molten sorbitol, spraying the molten sorbitol through at least one atomizing spray nozzle, and applying a plurality of layers of molten sorbitol to the confectionery to form a coated confectionery.

### PRIORITY CLAIM

This application is a continuation-in-part of U.S. patent application Ser. No. 11/024,214 filed on Dec. 22, 2004, which is a continuation-in-part of U.S. patent application Ser. No. 10/218,991 filed on Aug. 14, 2002, the entire disclosures of which are hereby incorporated.

### BACKGROUND

The present invention relates generally to confectionery products. More specifically, the present invention relates to coated confectionery products and methods of making same.

There are numerous types of confectionery products for consumers such as, for example, chewing gum, hard candy and soft candy. These confectioneries can have one or more outer coatings. The coatings can serve many purposes. For example, the coating can provide a barrier to limit moisture migration into and out of the confectionery center. The coatings can provide an initial sweetness or other desirable organoleptic property to the consumer. Further, the coatings can provide a crunching sensation when chewed by the consumer.

Initially, in creating coated chewing gums, sugar syrups or similar solutions were used to create the coating. Solutions, which may be in a liquid state at high temperature, contain a water component wherein the solute is dissolved or suspended. The coating is often achieved by spraying the hot solution onto the base confectionery item, spreading the syrup to distribute material onto all confectionery items, then cooling and drying the syrup solution to afford a solid coating.

Despite their widespread popularity in the confectionery industry, conventional solution-based coatings, such as sugar syrups, are in some ways disadvantageous. For example, an adequately thick coating typically cannot be achieved with a single spray application. Therefore, repeated cycles of spraying, distributing and drying are required to achieve a final coating that is sufficiently thick. The repeated spraying and drying process is complicated by the fact that drying each application typically requires the introduction of hot, dry air to remove moisture before spraying the next coat. This is due to the fact that solutions-based coatings have a moisture content that provides for the liquid property of the solution. This liquid characteristic is necessary for the coating solution to be sprayed or otherwise conveniently applied to the confectionery item. Of course, however, the moisture component must be removed after application in order for the coating to be transformed to a solid state.

These repeated cycles of spraying, distributing and drying are time-consuming and require specialized equipment. Indeed, elimination of the drying steps, for example, the use of hot, dry air, could reduce capital and energy expenditures associated with the equipment necessary to the drying process. Additionally, time and energy could be saved if a confectionery coating could be developed that requires fewer (and preferably, only one) spray applications in order to achieve an adequate coating thickness.

In recent years, polyol solutions have been used for coating confections, including chewing gums, as an alternative to sugar-based solution coatings. Polyol solutions, however, are similar to conventional sugar solutions in that they require repeated cycles of application and drying to remove the inherent water component contained therein.

There is therefore a need for an improved method of applying coating to chewing gums and other confections.

### SUMMARY

The present invention provides improved methods for coating confectionery products. In an embodiment, the present invention provides a method comprising providing a confectionery; heating sorbitol to the sorbitol's melting point to produce a molten sorbitol; and applying at least one layer of the molten sorbitol to the confectionery to form a coated confectionery. The method can also comprise applying one or more layers of a syrup composition to the confectionery center. The syrup composition can be a sorbitol syrup or any suitable syrup composition for coating confectioneries.

In an embodiment, applying the layer of the syrup composition can be chosen from the group consisting of spraying upon, pouring over the confectionery center and combinations thereof.

In an embodiment, the layers of the molten sorbitol and the syrup composition form a final coating mass on the coated confectionery with about 5-50% of the coating mass resulting from the molten sorbitol.

In an embodiment, the molten sorbitol can be applied by spraying the molten sorbitol through at least one atomizing spray nozzle.

In an embodiment, the at least one atomizing spray nozzle can be selected from the group consisting of an internal air mixing spray nozzle, an external air mixing spray nozzle and combinations thereof.

In an embodiment, the at least one atomizing spray nozzle has an atomizing air rate ranging from about 1.0-5.0 scfm/nozzle.

In an embodiment, the molten sorbitol can be applied at a rate ranging from about 20-250 g/min/nozzle.

In an embodiment, the molten sorbitol can be applied at a rate ranging from about 0.1-5.0 g/min/kg pellets.

In an embodiment, the molten sorbitol has a temperature ranging from about 105-130° C. during the application of the molten sorbitol.

In an embodiment, the method can comprise supplying a drying air flow to the confectionery while the coating layers are applied. For example, the drying air flow can be supplied at a rate ranging from about 180-280 m³/min. The drying air flow can have a temperature ranging from about 25-37° C.

In an embodiment, the method can comprise rotating the confectionery while the coatings are applied. For example, the coated confectionery can be rotated at a speed ranging from about 7-10 rpms.

In an embodiment, the method can comprise supplying a tempering air flow to the coated confectionery after the coating layers have applied. For example, the tempering air flow can have a temperature ranging from about 25-70° C.

In an embodiment, the molten sorbitol includes a non-sorbitol ingredient. For example, the non-sorbitol ingredient can be polyols, sucrose, fructose, maltose, glucose, dextrose, trehalose and combinations thereof.

In an embodiment, the confectionery can be hard candy, gummy candy, jelly candy, chewy candy, chewing gum, chocolate, fondants, nougats, compound candy, caramels, taffies, dragees, suspensions, lozenges, compressed tablets, capsules, nuts, snack foods and combinations thereof.

In an alternative embodiment, the present invention provides method of manufacturing a coated confectionery. For example, the method comprises providing a confectionery; heating sorbitol to the sorbitol's melting point to produce a molten sorbitol; spraying the molten sorbitol through at least one atomizing spray nozzle; and applying a plurality of layers to the confectionery to form a coated confectionery, the plurality of layers including at least one layer of molten sorbitol.

In an embodiment, the plurality of layers includes at least one layer of a syrup composition.

In an embodiment, the molten sorbitol can be applied prior to the application of the syrup composition.

In an embodiment, the syrup composition can be applied prior to the application of the molten sorbitol.

In an embodiment, the molten sorbitol may be applied concomitantly with the syrup composition.

In an embodiment, the application of molten sorbitol and the syrup composition can be repeated a plurality of times in order to form a final coating mass on the coated confectionery with about 5-50% of the coating mass resulting from the molten sorbitol.

In an embodiment, applying the syrup composition and the molten sorbitol can be performed in any sequence using any combination of mass applications, cooling, spreading, and drying.

In another embodiment, the present invention provides a coated confectionery comprising a confectionery and a molten sorbitol coating surrounding the confectionery.

In various embodiments, the present invention provides for compositions that are produced by the various methods embodied herein.

It is an advantage of the present invention to provide improved coatings for confectionery products as well as improved methods for forming such coatings.

Still another advantage of the present invention is to provide coating substances that can be sprayed onto confectionery items.

Moreover, an advantage of the present invention is to provide improved methods for applying coatings to an edible product including a center.

Another advantage of the present invention is to provide a method for building up a sufficient coating on a confectionery product involving shorter process times.

Additional features and advantages are described herein, and will be apparent from, the following Detailed Description and the figures.

### BRIEF DESCRIPTION OF THE FIGURES

FIG. 1 illustrates a schematic view of the process steps of an embodiment of the present invention.

FIG. 2 illustrates a cross-sectional view of an embodiment of a product of the present invention.

### DETAILED DESCRIPTION

The present invention provides for improved coated confectionery products as well as methods for coating confectionery products. More specifically, the present invention provides for improved sorbitol coating processes. Although in the preferred embodiments set forth below the confectionery product is chewing gum, the present invention is not limited to chewing gum. The present invention can be used to various foodstuff coatings and preferably confectionery products. The confectionery can be, for example, hard candy, gummy candy, jelly candy, chewy candy, chewing gum, chocolate, fondants, nougats, compound candy, caramels, taffies, dragees, suspensions, lozenges, compressed tablets, capsules, nuts, snack foods and combinations thereof.

In the present specification, the term “molten” (e.g. molten sorbitol) should be understood to refer to a solid composition that is heated to its melting point thereby forming a liquid or viscous material. As a result, a molten composition is distinguished from a syrup composition, which generally refers to a solution made by dissolving a powdered composition in a liquid.

In general, using xylitol, maltitol, and isomaltitol syrups take several hours (3-5) to coat to 30-35% weight gain. Typically, hard coating using sorbitol syrup can take 6-8 hours, and hard coating by sugar panning protocols can take 8-12 hours. The most time consuming component of the coating process is associated with the drying of water used to apply and distribute the coating solids in onto the confectionery centers in the hard panning process.

Application protocols can be different, for example, between xylitol and sorbitol coating processes in order to result in smooth, crunchy coated pellets. Typically, heavy xylitol syrup doses are used following molten xylitol sprays in order to redissolve, smooth, and refine the finish of a hard crystalline xylitol coating that results during xylitol process. In addition, molten xylitol applications are typically limited to the first ⅔s of pellet coating mass applied, while a thinner, finishing syrup is used judiciously to refine and achieve a smooth, uniform final pellet appearance. For example, in order to produce smooth, nicely finished pellets using molten xylitol, the molten sprays are generally slow spray rates, but molten xylitol leaves a frosted, crystalline appearance on the surface. In order to smooth this out, molten xylitol is generally shut off after ˜60% of the coating weight has been accumulated, then only finishing syrup is used to smooth the whole thing out in the final phases of coating.

In an embodiment, the molten sorbitol coating process can comprise using a slower molten spray rate that permits application of molten sorbitol virtually throughout the entire coating process while still resulting in excellent surface smoothness, appearance, texture and crunch without increasing pellet coating cycle time. For example, it was surprising found that, when using molten sorbitol pellet in an embodiment of the present invention, roughness never appeared to be an issue, and consequently, molten sorbitol could be alternately sprayed with sorbitol syrup throughout a number of phases and the final sizing phase without poor consequences toward appearance.

In the conventional coating process for sorbitol, a high purity liquid sorbitol is used. By using this grade of liquid sorbitol, the sticking that occurs during coating is minimized. Lower purity grades of liquid sorbitol can be used and an acceptable product still be obtained. However, from a processing point of view the higher purity is preferred. For example, a preferred purity range is between about 68% to 98% sorbitol.

Sorbitol coatings are different from the conventional confectionery coatings made with other polyols such as maltitol, isomalt or xylitol. For example, during sorbitol syrup coating, the pellets actually ride higher up in the pan and crash on the spray arm of the driam. Also, the degree of sticking is higher with sorbitol. To combat this process, liquid flavors used in the coating can be added to the syrup. Because the syrup is held at about 30° C., the volatilization of the flavor components is at a minimum.

Significant process cycle-time savings can be realized through the reduction of water content in the coating syrups, providing adequate coating solids distribution can be maintained. In practice, pan coating processes have increased syrup solids contents to 70-80° Brix and 60-80° C. to provide sufficient moisture to maintain the polyol in solution/suspension, yet maintain the minimum amount of water necessary to spray, distribute, and smooth the syrup on the confectionery centers. In spite of this, 70-98% of the overall process coating times are used for drying of associated moisture from the coatings being applied to the confectionery centers.

Application of molten or fused confectionery coatings can substantially reduce process cycle times through elimination of current water drying times in syrup-based processes. Additional benefits of the present invention include good adhesion to confectionery cores, adequate uniformity of distribution to cover all pieces equally, dissipation of both latent heat and sensible heat loads, and adequate binding, spreading, and filling of surface imperfections to afford a generally smooth surface and a coated shell with good integrity and homogeneity.

While using a high purity syrup does help with reducing the sticking, dry charge may also be needed in a conventional syrup coating process. Dry charge can constitute about 66% of the sorbitol syrup coating. In an embodiment of the present invention, the molten sorbitol coating process can be done without using dry charge to still achieve a sufficiently thick coating, which can lead to processing cost and time savings.

The present invention provides reduced exposure to moisture through development of hard coatings by using a molten coating protocol. This is beneficial during the production of dry or solid pharmaceutical dosage forms which comprise ingredients that are often sensitive to degradation through contact with moisture or water during processing.

The present invention generally provides for the use of molten sorbitol and other molten substances or syrups to coat confectionery products, and more specifically, chewing gum. In the case of chewing gum, for example, the molten polyol coating is typically applied to chewing gum centers. Pursuant to the present invention, time, energy, and equipment costs are reduced due to the reduction and/or elimination of the need to perform repeated cycles of spraying and drying of the coating syrup. In this regard, the molten polyol coatings of the present invention can be applied in single spray application without the need for drying involving the introduction of hot, dry air. However, more than one coating application can be used.

The molten polyols of the present invention can reduce or eliminate the need for repeated cycles of spraying and drying because the molten polyols do not possess the high water content found in conventional non-molten, syrup-based coating substances. In this regard, the polyols featured herein can be liquefied by the introduction of sufficient heat levels, rather than by the introduction of moisture. In other words, when sufficiently heated, a given polyol will melt and will remain in a molten state until it is allowed to cool to a temperature below its melting point. Polyol, as used herein, can broadly refer to a single polyol, blend of polyols, or polyol mixture.

For pure polyols, the melting point can be considered its published value. For example, xylitol has a published melting point of 92-95° C., sorbitol has a published value of 99-101° C., maltitol has a published value of 144-147° C. It should be appreciated that compositions arising from blends of polyols, or fusion of impure polyols or polyols with other additives, can sometimes have dramatically altered melting points above or below the published value of the major component. Preferred heating ranges for the molten polyol of an embodiment of the present invention would be about 100%-140% of the polyol's melting point (° C.). More preferably, the range would be about 100%-130% of the polyol's melting point (° C.). Most preferably, the range would be about 100%-120% of the polyol's melting point (° C.).

The molten sorbitol can in various embodiments of the present invention can be applied, preferably by atomizing spray application, to the gum center while the polyols are in a molten state. Thereafter, the coated gum is allowed to cool, a process that enables the polyol to transform from a molten state back to a solid state.

The molten sorbitol coatings of the present invention may include non-polyol ingredients which are commonly used in sugar and sugarless coatings. For example, sugar products such as sucrose, fructose, maltose, glucose, dextrose, and trehalose or combinations thereof could be applied from a molten state to provide a hard-coated sugar confectionery or other center/core. The specific ingredients and their usage levels will vary greatly according to the intentions for the formulation.

The use of one or more fillers (e.g., titanium dioxide, talc, calcium carbonate, silicon dioxide) in the present invention is especially advantageous. In this regard, these inorganic materials aid the coating process by giving the molten polyol coatings a smoother finish, especially when using molten polyols having a higher melting point, such as maltitol. Furthermore, these inorganic fillers enhanced the ease with which molten sorbitol could be used, and in many instances substantially increased the crunchiness of the product. These fillers also appear to facilitate crystallization of the applied polyol once the molten material adheres to the centers being coated. Without adding an inorganic filler to molten sorbitol, the coating is excessively sticky, causing coating problems, e.g., the pellets may stick together. Likewise, without inorganic filler added to molten maltitol, the spray exiting the nozzle is unsuitable for coating smooth pellets. Moreover, the use of non-polyol can reduce the spider-web structures created by spraying maltitol.

As noted above, a suitable final molten polyol coating can typically be achieved with comparatively few spray applications. If desired, a number of short spray sessions can be performed. The final thickness of the polyol coating will vary greatly according to the preference of the practitioner of the present invention. For example, it may be desirable to have a thin coating or, on the other hand, it may be desirable to have a thick coating. In an embodiment, the coating is such that it exceeds 50% by weight of the total product. However, a thinner coating can be used if desired.

Various polyols may not be identical in their physical and chemical characteristics. The variability among the polyols therefore allows one to blend two or more different molten polyols prior to application. Similarly, it may be desirable to build-up multiple coating layers using single or blended polyols for the individual coating layers.

Molten polyol coatings can result in a finished product that, when compared to conventional non-molten coatings, is rougher in appearance. As used herein, the term “conventional non-molten coatings,” and like terms, are intended to broadly refer to any coating substance or syrup that is not in a molten state, but dissolved or dispersed in an aqueous or other solvent-based media, and applied to a given confectionery item. A non-molten coating substance or syrup can include, but is not limited to, sugar syrups, polyol syrups, other solutions, suspensions, pastes, and gels.

It should be noted that xylitol or sorbitol, whose melting points are below 100° C. (point where water boils) can be made less viscous by the addition of a small amount of water. Other polyols melt at temperatures above 100° C., and may also be made less viscous with addition of small amounts of water. However, water will evaporate rapidly when these polyols are heated and maintained at temperatures above 100° C. to maintain a homogeneous fluid.

Glycerin behaves similar to water. By introducing a small amount of glycerin, the temperature necessary to achieve a fluid state can be reduced. Glycerin's boiling point is 125.5° C. Thus, a small amount of glycerin can be used to melt erythritol (melting point of 121.5° C.) at a lower temperature than the crystal melting temperature. By adding small amounts of water or glycerin, the viscosity of the molten polyol is lower and allows for easier spraying or atomization.

Because molten polyol coatings can appear and feel rough to the consumer, it may be desirable to first coat the product with one or more molten polyol coatings, and then complete the coating process by using one or more conventional non-molten coatings in order to provide a final product with a smooth surface.

In an alternative embodiment, it is also possible to produce a coated confectionery containing the molten polyol, potentially with high intensity sweeteners, flavor, color, filler, binder, or film forming agents having a rough texture or appearance. For example, a frosted, flavored or sweetened coating could be applied in an embodiment of the present invention to confectionery products to provide an alternative surface finish and means of introducing a high-initial-impact product.

Additionally, it may be desirable to initially establish at least one coating layer using at least one conventional non-molten coating, over which at least one molten polyol coating of the present invention may be applied. Similarly, depending on the desired outcome, it may be preferable to employ alternating layers of molten polyol coatings and conventional non-molten coatings. Therefore the molten polyol coatings described herein can be utilized as the sole coating or can be utilized in combination with one or more other coating layers that comprise any type of conventional non-molten coating.

The molten polyol coatings of the present invention can be melted by methods known in the art. In an embodiment, the polyol is liquefied by heating a composition that includes 5% or less water. By way of example and not limitation, the coating materials can be melted by using a hotmelt apparatus such as the ROBATECH® Hotmelt Unit. However, other means such as a steam jacketed melting tank can be used.

Preferably, a jacketed atomizing spray nozzle is used. The jacketed atomizing sprayer will maintain the temperature of the molten polymer through the tip of the nozzle. Then, atomization will assist in cooling down the temperature of the molten polyol droplets before they hit the centers (pellets). After the coating material is transformed into a molten state, it can be applied to gum centers using processes, techniques, and equipment suited for the application of conventional non-molten coatings.

Finely atomized molten spray droplets produce very fine molten droplets which remain tacky throughout the transit distance and time between the nozzle and the surface of the pellets. These droplets bind or attach to the surface of the coated centers and smear or spread slightly. Throughout the spray duration, repeated passes of pellets through the spray application leads to very uniform, yet finely roughened, buildup of polyol onto the tumbling bed of coated centers. Because the process generates a fine mist or fog of molten polyol targeted to the rotating bed of pellets, the droplets are still tacky and stick to the centers, rather than becoming a dry dust and being exhausted from the pan without ever sticking to the centers. This results in high coating efficiencies. For example, 70-100% or typically 90-95% of applied molten spray ends up attached to the pellets, and not coating the pan or venting out the dust collector.

As noted previously, it may be desirable to provide chewing gum products that have different coating layers comprising molten polyols and conventional non-molten (e.g. syrup) coatings. In this regard, both such coating types can be applied using methods known in the art, such as spraying the coating materials onto the gum pellets. Spraying can be alternately started and stopped to allow layers of coating to dry onto the surface of the pieces. Forced air and dry powder additionally may be used to speed the drying process. The various parameters of the operation (spray time, dry time, air temperature, tumbling speed and others) will vary greatly from one system to another and may well vary within a coating batch and from batch to batch. They will be set based on the skill and experience of the developer and operator.

Typical coating equipment usable in the present invention can include any suitable apparatus normally used for this purpose, with the exception of the spray nozzles, which must be atomizing nozzles to spray the molten polyol. Simple systems may comprise conventional motor-driven coating pans with manually controlled spray nozzles and drying air. However, more sophisticated automated systems including, for example, DRIAM® and DUMOULIN® Coaters, GS perforated coating pans, Latini, Thomas Coating side-ventilated pans and others similar systems are preferred.

In addition to the coatings of the present invention applied by spraying, optionally flavors may be separately sprayed onto the pieces during the coating process to provide a flavored coating. If used, this flavor may constitute from about 0.01 to 3% of the total coating with levels of 0.5 to 2% being preferred.

Optionally a final polishing coat may be applied to the pieces after the polyol coatings have been applied. The polishing coat may use a wax, such as carnauba wax, or shellac. It may also include fillers such as talc and colors. The polishing coat is typically 0.01 to 0.5% of the total coating.

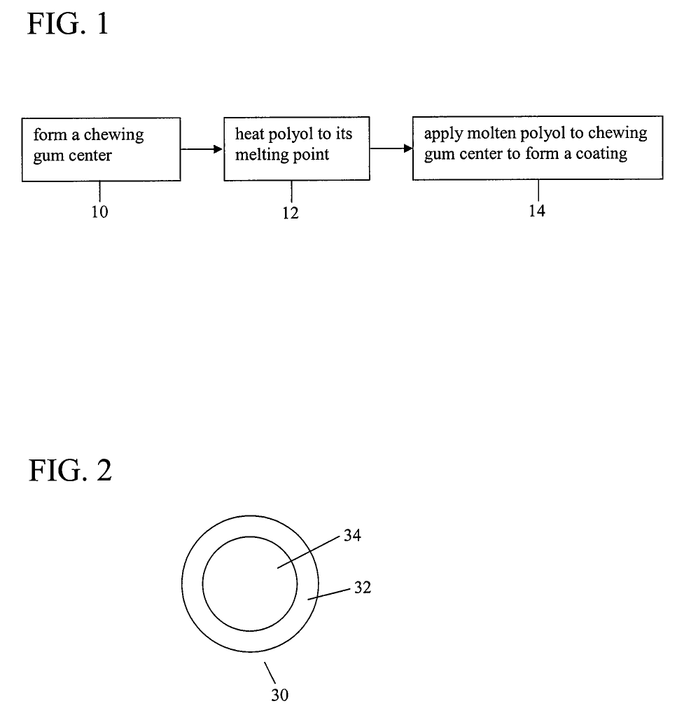

FIG. 1 illustrates a schematic view of the process steps of an embodiment of the present invention. As illustrated in a first step 10 a center is formed. In a second step 12 a polyol is heated to its melting point. In the third step 14 the polyol is applied to the gum center.

As noted above, the present invention can be used to create coated chewing gum. FIG. 2 illustrates such a product 30. The product 30 includes a coating 32 and gum center 34. A variety of chewing gum formulations can be used to create the chewing gum center 34. Chewing gum generally consists of a water insoluble gum base, a water soluble portion, and flavors.

The insoluble gum base generally comprises elastomers, resins, fats and oils, softeners, and inorganic fillers. The gum base may or may not include wax. The insoluble gum base can constitute approximately 5 to about 95 percent, by weight, of the chewing gum, more commonly, the gum base comprises 10 to about 50 percent of the gum, and in some preferred embodiments, 20 to about 35 percent, by weight, of the chewing gum.

In an embodiment, the chewing gum of the present invention contains about 20 to about 60 weight percent synthetic elastomer, 0 to about 30 weight percent natural elastomer, about 5 to about 55 weight percent elastomer plasticizer, about 4 to about 35 weight percent filler, about 5 to about 35 weight percent softener, and optional minor amounts (about one percent or less) of miscellaneous ingredients such as colorants, antioxidants, etc.

Synthetic elastomers may include, but are not limited to, polyisobutylene with a GPC weight average molecular weight of about 10,000 to about 95,000, isobutylene-isoprene copolymer having styrene-butadiene ratios of about 1:3 to about 3:1, polyvinyl acetate having a GPC weight average molecular weight of about 2,000 to about 90,000, polyisoprene, polyethylene, vinyl acetate-vinyl laurate copolymer having vinyl laurate content of about 5 to about 50 percent by weight of the copolymer, and combinations thereof.

Preferred ranges are, for polyisobutylene, 50,000 to 80,000 GPC weight average molecular weight, for styrene-butadiene, for polyvinyl acetate, 10,000 to 65,000 GPC weight average molecular weight with the higher molecular weight polyvinyl acetates typically used in bubble gum base, and for vinyl acetate-vinyl laurate, vinyl laurate content of 10-45 percent.

Natural elastomers may include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Natural elastomers may include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. The preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers may include, but are not limited to, natural rosin esters, often called estergums, such as glycerol esters of partially hydrogenated rosin, glycerol esters polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing the preferred elastomer plasticizers will also vary depending on the specific application, and on the type of elastomer which is used.

Fillers/texturizers may include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers may include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners may include FD&C-type dyes and lakes, fruit and vegetable extracts, titanium dioxide, and combinations thereof.

The base may or may not include wax. An example of a wax-free gum base is disclosed in U.S. Pat. No. 5,286,500, the disclosure of which is incorporated herein by reference.

In addition to a water insoluble gum base portion, a typical chewing gum composition includes a water soluble bulk portion and one or more flavoring agents. The water soluble portion can include bulk sweeteners, high intensity sweeteners, flavoring agents, softeners, emulsifiers, colors, acidulants, fillers, antioxidants, and other components that provide desired attributes.

The softeners, which are also known as plasticizers and plasticizing agents, generally constitute between approximately 0.5 to about 15% by weight of the chewing gum. The softeners may, in addition to including caprenin, include glycerin, lecithin, and combinations thereof. Aqueous sweetener solutions such as those containing sorbitol, hydrogenated starch hydrolysates, corn syrup and combinations thereof, may also be used as softeners and binding agents in chewing gum.

Bulk sweeteners include both sugar and sugarless components. Bulk sweeteners typically constitute 5 to about 95% by weight of the chewing gum, more typically, 20 to 80% by weight, and more commonly, 30 to 60% by weight of the gum. Sugar sweeteners generally include saccharide-containing components commonly known in the chewing gum art, including, but not limited to, sucrose, dextrose, maltose, dextrin, dried invert sugar, fructose, levulose, galactose, corn syrup solids, and the like, alone or in combination. Sugarless sweeteners can include, but are not limited to, other sugar alcohols such as sorbitol, mannitol, xylitol, hydrogenated starch hydrolysates, maltitol, lactitol, and the like, alone or in combination.

High intensity artificial sweeteners can also be used in combination with the above. Preferred sweeteners include, but are not limited to sucralose, aspartame, aspartame derivatives and conjugates, such as neotame, salts of acesulfame, alitame, saccharin and its salts, cyclamic acid and its salts, glycyrrhizin, dihydrochalcones, thaumatin, monellin, and the like, alone or in combination. In order to provide longer lasting sweetness and flavor perception, it may be desirable to encapsulate or otherwise control the release of at least a portion of the artificial sweetener. Such techniques as wet granulation, wax granulation, spray drying, spray chilling, fluid bed coating, coacervation, and fiber extension may be used to achieve the desired release characteristics.

Usage level of the artificial sweetener will vary greatly and will depend on such factors as potency of the sweetener, rate of release, desired sweetness of the product, level and type of flavor used and cost considerations. Thus, the active level of artificial sweetener may vary from 0.02 to about 8%. When carriers used for encapsulation are included, the usage level of the encapsulated sweetener will be proportionately higher.

Combinations of sugar and/or sugarless sweeteners may be used in chewing gum. Additionally, the softener may also provide additional sweetness such as with aqueous sugar or alditol solutions.

If a low calorie gum is desired, a low caloric bulking agent can be used. Example of low caloric bulking agents include: polydextrose; Raftilose, Raftilin; Fructooligosaccharides (NutraFlora); Palatinose oligosaccharide; Guar Gum Hydrolysate (Sun Fiber); or indigestible dextrin (Fibersol). However, other low calorie bulking agents can be used.

A variety of flavoring agents can be used. The flavor can be used in amounts of approximately 0.1 to about 15 weight percent of the gum, and preferably, about 0.2 to about 5%. Flavoring agents may include essential oils, synthetic flavors or mixtures thereof including, but not limited to, oils derived from plants and fruits such as citrus oils, fruit essences, peppermint oil, spearmint oil, other mint oils, clove oil, oil of wintergreen, anise and the like. Artificial flavoring agents and components may also be used. Natural and artificial flavoring agents may be combined in any sensorially acceptable fashion.

A variety of processes for manufacturing chewing gum center are possible as is known in the art. For example, chewing gum can be generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, extruding into chunks, or casting into pellets.

Generally, the ingredients are mixed by first melting the gum base and adding it to the running mixer. The gum base may alternatively be melted in the mixer. Color and emulsifiers can be added at this time, along with syrup and a portion of the bulking agent. Further portions of the bulking agent may then be added to the mixer. A flavoring agent is typically added with the final portion of the bulking agent. The entire mixing procedure typically takes from five to fifteen minutes, but longer mixing times may sometimes be required. Those skilled in the art will recognize that many variations of the above described procedures may be followed.

Once formed, the chewing gum center can be coated. In conventional panning, the coating is initially present as a liquid syrup which contains from about 30% to about 80% or 85% of the coating ingredients previously described herein, and from about 15% or 20% to about 70% of a solvent such as water. In general, the coating process is carried out in conventional panning equipment. Sugarless gum center tablets to be coated are placed into the panning equipment to form a moving mass.

In the conventional panning process, the material or syrup which will eventually form the coating is applied or distributed over the gum center tablets. Flavors may be added before, during and after applying the syrup to the gum centers. Once the coating has dried to form a hard surface, additional syrup additions can be made to produce a plurality of coatings or multiple layers of coating.

In the conventional panning procedure, syrup is added to the gum center tablets at a temperature of from about 100° F. to about 240° F. Preferably, the syrup temperature is from about 140° F. to about 200° F. Most preferably, the syrup temperature should be kept constant throughout the process in order to prevent the polyol in the syrup from crystallizing. The syrup may be mixed with, sprayed upon, poured over, or added to the gum center tablets in any way known to those skilled in the art.

In some instances, a soft coating is formed by adding a powder coating after a liquid coating. The powder coating may include natural carbohydrate gum hydrolysates, maltodextrin, gelatin, cellulose derivatives, starches, modified starches, sugars, sugar alcohols, natural carbohydrate gums and fillers like talc and calcium carbonate.

Each component of the coating on the gum center may be applied in a single layer or in a plurality of layers. In general, a plurality of layers is obtained by applying single coats, allowing the layers to dry, and then repeating the process. The amount of solids added by each coating step depends chiefly on the concentration of the coating syrup. Any number of coats may be applied to the gum center tablet. Preferably, no more than about 75 coats are applied to the gum center. More preferably, less than about 60 coats are applied and most preferably, about 30 to 60 coats are applied. In any event, the present invention contemplates applying an amount of molten polyol and syrup sufficient to yield a coated chewing gum product containing about 10% to about 65% coating. Preferably, the final product will contain at least 30% coating.

Those skilled in the art will recognize that in order to obtain a plurality of coated layers, a plurality of premeasured aliquots of coating syrup may be applied to the gum center. It is contemplated, however, that the volume of aliquots of syrup applied to the gum center may vary throughout the coating procedure.

In the conventional coating process, once a coating of syrup is applied to the gum center, the wet centers are tumbled briefly with no air flow to uniformly distribute syrup across all pellets of the bed, and then drying is done on the wet syrup in an inert medium. A preferred drying medium comprises air. Preferably, forced drying air contacts the wet syrup coating in a temperature range of from about 70° F. to about 110° F. More preferably, the drying air is in the temperature range of from about 80° F. to about 100° F. The invention also contemplates that the drying air possess a relative humidity of less than about 15 percent. Preferably, the relative humidity of the drying air used between syrup applications is less than about 8 percent.

The drying air may be passed over and admixed with the syrup coated gum centers in any way commonly known in the art. Preferably, the drying air is blown over and around the syrup coated gum centers at a flow rate, for large scale operations, of about 2800 cubic feet per minute. If lower quantities of material are being processed, or if smaller equipment is used, lower flow rates would be used. If a flavor is applied after a syrup coating has been dried, the present invention contemplates drying the flavor with or without the use of a drying medium.

By way of example and not limitation, the following examples are illustrative of various embodiments of the present invention. Certain methods for making sorbitol coated confectionery products according to the present invention will be described below.

In an embodiment, the present invention provides a method comprising providing a confectionery; heating sorbitol to the sorbitol's melting point to produce a molten sorbitol; and applying at least one layer of the molten sorbitol to the confectionery to form a coated confectionery. The method can also comprise applying one or more layers of a syrup composition to the confectionery center. The syrup composition can be a polyol syrup or any suitable syrup composition for coating confectioneries. It should be appreciated that applying the layer of the syrup composition can be done in any suitable manner such as, for example, spraying upon, pouring over the confectionery center and combinations thereof.

The layers of the molten sorbitol and the syrup composition can form a final coating mass on the coated confectionery with about 5-50% of the coating mass resulting from the molten sorbitol.

In another embodiment, the molten sorbitol can be applied by spraying the molten sorbitol through one or more atomizing spray nozzles. For example, the atomizing spray nozzle can be an internal air mixing spray nozzle, an external air mixing spray nozzle and combinations thereof. The atomizing spray nozzle can have an atomizing air rate ranging from about 1.0-5.0 scfm/nozzle.

In an alternative embodiment, the molten sorbitol can be applied at a rate ranging from about 20-250 g/min/nozzle. The molten sorbitol can be applied at a rate ranging from about 0.1-5.0 g/min/kg pellets. The molten sorbitol can have a temperature ranging from about 105-130° C. during the application of the molten sorbitol.

In another embodiment, the method can comprise supplying a drying air flow to the confectionery while the coating layers are applied. For example, the drying air flow can be supplied at a rate ranging from about 180-280 m³/min. The drying air flow can have a temperature ranging from about 25-37° C.

In an embodiment, the method can comprise rotating the confectionery while the coatings are applied. For example, the coated confectionery can be rotated at a speed ranging from about 7-10 rpms.

In an embodiment, the method can comprise supplying a tempering air flow to the coated confectionery after the coating layers have applied. The tempering air flow can be supplied, for example, after the final coating layers have been applied to the confectionery (e.g. post-coating process). The tempering air flow can have a temperature ranging from about 25-70° C.

It should be appreciated that the molten sorbitol can include any suitable non-sorbitol ingredient. For example, the non-sorbitol ingredients can be polyols, sucrose, fructose, maltose, glucose, dextrose, trehalose and combinations thereof.

In an alternative embodiment, the present invention provides method of manufacturing a coated confectionery. For example, the method comprises providing a confectionery; heating sorbitol to the sorbitol's melting point to produce a molten sorbitol; spraying the molten sorbitol through at least one atomizing spray nozzle; and applying a plurality of layers to the confectionery to form a coated confectionery, the plurality of layers including at least one layer of molten sorbitol. The plurality of layers can include at least one layer of a syrup composition.

The molten sorbitol can be applied prior to, during or after the application of the syrup composition. The application of molten sorbitol and the syrup composition can be repeated any suitable number of times in order to form, for example, a final coating mass on the coated confectionery with about 5-50% of the coating mass resulting from the molten sorbitol. In another embodiment, applying the syrup composition and the molten sorbitol can be performed in any numbers and sequences and using any combination of mass applications, cooling, spreading (e.g. rotating), and drying. It should be appreciated that the number of sequences/cycles (e.g. apply, rotate, dry) and number of molten sorbitol and syrup composition coating applications can vary and depend on a variety of factors such as, for example, the type of equipment used, ambient air conditions, the desired type of finished coating, the components of the syrup composition or additional components added to the coating, etc.

Replacement of some of the coating mass by molten polyol (by reducing the number of syrup addition cycles) can be done to provide identical surface finish, weight, appearance, texture, and organoleptic properties. This typically encompasses 5-65% of the coating mass to be applied via molten polyol spray application in lieu of conventional coating syrup, more preferably 10-45%, and most preferably 15-40%. In these cases, use of conventional coating syrups are often used to provide good binding of coating layers to the chewing gum core, or to provide a smooth, hard coated finish typical of current commercial products available on the market. It should be appreciated that new coating texture, non-conventional coating appearance, and textures not typically associated with commercial chewing gum products commercially available can be obtained if no conventional coating syrup is used in conjunction with molten polyol spray applications, or if molten polyol sprays are used for a majority of the coating process, or as finishing stages of a conventional coating process.

In an alternative embodiment, the step of applying the layer of the syrup composition to the confectionery center includes the step of mixing with, spraying upon, pouring over or any other suitable method of applying the syrup composition to the confectionery center. Each layer of molten polyol and syrup may be dried before another layer is applied.

In an embodiment, the end of the atomizing spray nozzle may include a fluid cap and/or an air cap. The fluid cap orifice diameter regulates, limits and controls the maximum flow rate of molten liquid spraying from nozzle. For example, fluid cap #60100DF from Spraying Systems was used during testing because it provided the largest diameter liquid orifice and the opportunity for the greatest molten spray rate.

In an alternative embodiment, the air cap available for these nozzles may be provided in any suitable configuration such as internal air mixing and external air mixing. The internal mixing of atomizing air and molten liquid provide a finer particle or molten droplet, is more reliable, is less likely to beard, and is more resistant to clogging or freezing of the molten sorbitol.

The temperature of the hot air used for atomization of molten sorbitol can range between 100° C. and 250° C. The atomizing air pressure may generally be set between 0.5 bar to 7.0 bar. The atomizing air flow rates through the nozzle can range between 10 liters/min/nozzle and 240 liters/min/nozzle. Preferably, the atomizing air pressure between 1.0-5.0 bar and atomizing air flow rates of 60-120 liters/min/nozzle at 160-230° C.

Atomizing air spray rates can vary greatly, and are strongly influenced by the molten material spray rate, material viscosity and surface tension, and geometry of the nozzle tip and spray pattern. It should be appreciated that spray nozzle parameters of various embodiments of the present invention (molten spray rate, atomizing air, nozzle tip, and temperature) can be modified to provide uniform distribution of fine molten polyol droplets which remain molten and tacky during the transit from the nozzle to the pellet surface.

Other preferred operating conditions can utilize higher or lower molten sorbitol spray rates with concomitant increases or decreases in atomizing air flow rates in order to maintain a uniform and finely atomized mist of sorbitol droplets. Atomized air flow rates set too low for a given molten sorbitol delivery rate will result in incomplete atomization, spitting, and macroscopic dripping of molten sorbitol from the nozzle tip. Atomized air rates set too high will result in a dusty sorbitol mist which can cool and solidify prior to contacting the confectionery centers, and resulting in low process yields. Atomization air temperatures are set based upon molten and atomizing air spray rates, and are adjusted to minimize freezing of sorbitol on the nozzle tip and maintain a the finely atomized sorbitol in a molten state until it has the opportunity to attach and solidify on the centers being coated. This combination of air and molten polyol affords good atomization and fine mist of molten droplets which coats the pellets well.

Flat fan-shaped sprays, cone-shaped sprays or any suitable shaped sprays of atomized molten sorbitol may be used to coat the pellets. Preferably, cone nozzles may be used because they produce less bearding, for example, solid sorbitol solidifying upon leaving nozzle tip. Cone nozzles may provide more localized and intense spray regions with less spray in between nozzles, however both types of nozzles can be used successfully to provide good uniformity of coating among all pellets within a pellet bed. Spray rates, bed speed, and atomization air flow can all be modified to make sure all pellets in the bed are exposed to uniform spraying of sorbitol.

If the typical process time associated with the target weight gain of the pellet center is considered, overall process time savings using different embodiments of the present invention could be measured in various ways. For example, during a typical 6 hour coating process, use of molten sprayed mass for some of the coating material could produce the identical product in a process time savings of 30 minutes, 60 minutes, 90 minutes, etc. (i.e. −5%, 10%, 24%, 37% times savings). Alternatively, the present invention could produce a better quality product in a comparable 6 hour process time.

The following table provides additional examples of ranges of various aspects of the sorbitol coating process in embodiments of the present invention.

TABLE 1

| | Approximate Molten Sorbitol Coating |
|---|---|
| | Conditions |
| Typical Coating Time | 3-5 hrs |
| Applied Sorbitol Syrup | 25-35° C. |
| Temperature | 29-31° C. preferred |
| Applied Molten Sorbitol | 105-130° C. |
| Temperature | 115-125° C. preferred |
| Molten Spray Rate | 20-250 g/min/nozzle {2 nozzles} |
| | or 0.1-5.0 g/min/kg pellets loaded |
| | 30-180 g/min/nozzle |
| | or 0.2-3.0 g/min/kg |
| | pellet centers loaded typical |
| | 40-150 g/min/nozzle |
| | or 0.6-2.5 g/min/kg |
| | pellet centers loaded preferred |
| Atomizing Air Rate | 1.0-5.0 scfm/nozzle |
| | 1.6-3.5 scfm/nozzle preferred |
| | Atomizing air temperature is maintained |
| | above melting point of sorbitol to keep |
| | nozzle from freezing. |
| | (e.g. 120-250° C.; |
| | 170-225° C. preferred) |
| Drying Air Temperature*** | 25-37° C. |
| | 26-30° C. preferred |
| Drying Air Flowrate | 180-280 |
| (m³/min)*** | 210-230 preferred |
| Drum Speed (rpm) (2 m Drum) | 7-10 rpm |
| Air Tempering Time (post- | 4-8 hrs |
| coating application process) | 5.5-6.5 hrs preferred |
| Air Tempering Temperature | 25-70° C. |
| | 45-55° C. preferred |
| Percentage Molten Coating | 5-50% of coating mass |
| | applied as molten |
| Composition | 15-30% preferred |

***Dry air refers to the drying air in the driam not tempering air.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A method comprising:
providing a confectionery;
heating sorbitol to the sorbitol's melting point to produce a molten sorbitol; and
applying at least one layer of the molten sorbitol to the confectionery to form a coated confectionery.

2. The method of claim 1, comprising applying at least one layer of a syrup composition to the confectionery center.

3. The method of claim 2, wherein applying the layer of the syrup composition is chosen from the group consisting of spraying upon, pouring over the confectionery center and combinations thereof.

4. The method of claim 2, wherein the layers of the molten sorbitol and the syrup composition form a final coating mass on the coated confectionery with about 5-50% of the coating mass resulting from the molten sorbitol.

5. The method of claim 1, wherein the molten sorbitol is applied by spraying the molten sorbitol through at least one atomizing spray nozzle.

6. The method of claim 5, wherein the at least one atomizing spray nozzle is selected from the group consisting of an internal air mixing spray nozzle, an external air mixing spray nozzle and combinations thereof.

7. The method of claim 5, wherein the at least one atomizing spray nozzle has an atomizing air rate ranging from about 1.0-5.0 scfm/nozzle.

8. The method of claim 5, wherein the molten sorbitol is applied at a rate ranging from about 20-250 g/min/nozzle.

9. The method of claim 5, wherein the molten sorbitol is applied at a rate ranging from about 0.1-5.0 g/min/kg pellets.

10. The method of claim 1, wherein the molten sorbitol has a temperature ranging from about 105-130° C. during the application of the molten sorbitol.

11. The method of claim 1, comprising supplying a drying air flow to the confectionery while the coating layers are applied.

12. The method of claim 11, wherein the drying air flow is supplied at a rate ranging from about 180-280 m³/min.

13. The method of claim 11, wherein the drying air flow has a temperature ranging from about 25-37° C.

14. The method of claim 1, comprising rotating the confectionery while the coatings are applied.

15. The method of claim 14, wherein the coated confectionery is rotated at a speed ranging from about 7-10 rpms.

16. The method of claim 1, comprising supplying a tempering air flow to the coated confectionery after the coating layers have applied.

17. The method of claim 16, wherein the tempering air flow has a temperature ranging from about 25-70° C.

18. The method of claim 1, wherein the molten sorbitol includes a non-sorbitol ingredient.

19. The method of claim 18, wherein the non-sorbitol ingredient is selected from the group consisting of polyols, sucrose, fructose, maltose, glucose, dextrose, trehalose and combinations thereof.

20. The method of claim 1, wherein the confectionery is selected from the group consisting of hard candy, gummy candy, jelly candy, chewy candy, chewing gum, chocolate, fondants, nougats, compound candy, caramels, taffies, dragees, suspensions, lozenges, compressed tablets, capsules, nuts, snack foods and combinations thereof.

21. A method of manufacturing a coated confectionery, the method comprising:
providing a confectionery;
heating sorbitol to the sorbitol's melting point to produce a molten sorbitol;
spraying the molten sorbitol through at least one atomizing spray nozzle; and
applying a plurality of layers to the confectionery to form a coated confectionery, the plurality of layers including at least one layer of molten sorbitol.

22. The method of claim 21, wherein the plurality of layers includes at least one layer of a syrup composition.

23. The method of claim 22, wherein the molten sorbitol is applied prior to the application of the syrup composition.

24. The method of claim 22, wherein the syrup composition is applied prior to the application of the molten sorbitol.

25. The method of claim 22, wherein the molten sorbitol may be applied concomitantly with the syrup composition.

26. The method of claim 22, wherein the application of molten sorbitol and the syrup composition is repeated a plurality of times in order to form a final coating mass on the coated confectionery with about 5-50% of the coating mass resulting from the molten sorbitol.

27. The method of claim 22, wherein applying the syrup composition and the molten sorbitol is performed in any sequence using any combination of mass applications, cooling, spreading, and drying.

28. A coated confectionery comprising a confectionery and a molten sorbitol coating surrounding the confectionery.

29. The confectionery of claim 28, wherein the confectionery is selected from the group consisting of hard candy, gummy candy, jelly candy, chewy candy, chewing gum, chocolate, fondants, nougats, compound candy, caramels, taffies, dragees, suspensions, lozenges, compressed tablets, capsules, nuts, snack foods and combinations thereof.
